(19) United States
(12) Patent Application Publication
(10) Pub. No.: US 2026/0336780 A1
(43) Pub. Date: Oct. 29, 2026

(54) CONNECTING ARRANGEMENT FOR CONNECTING STRUCTURAL PARTS OF AN AIRCRAFT

(71) Applicant: Airbus Operations GmbH, HAMBURG (DE)

(72) Inventors: Florian LEICHSNER, HAMBURG (DE); Steffen DIETRICH, HAMBURG (DE)

(21) Appl. No.: 19/656,575

(22) Filed: Apr. 23, 2026

(30) Foreign Application Priority Data
Apr. 25, 2025 (DE) 102025001380.9

(51) Int. Cl. B64C 1/06; B64F 5/10

(52) U.S. Cl. CPC B64C 1/069; B64F 5/10

(57) ABSTRACT

A connecting arrangement for structural parts of an aircraft. A first structural part has a first flange segment, a second structural part has a second flange segment; and a connecting device connects the two flange segments. The structural parts form an outer surface of the aircraft. The flange segments abut each other along a connecting plane in a connected state and each have at least one through-opening which are aligned with each other. In the connected state a connecting element of the connecting device protrudes through the through-openings in a connecting direction to connect the flange segments to each other. The connecting direction runs transversely to the connecting plane and the connecting plane is arranged inclined to the outer surface such that the connecting direction runs obliquely to the outer surface and intersects it.

### CROSS-REFERENCES TO RELATED APPLICATIONS

This application claims the benefit of German Patent Application Number 102025001380.9, filed on Apr. 25, 2025, the entire disclosure of which is incorporated herein by way of reference.

### FIELD OF THE INVENTION

The present invention relates to the connection of structural parts and in particular relates to a connecting arrangement for connecting structural parts of an aircraft, to an aircraft and to a method for connecting structural parts of an aircraft.

### BACKGROUND OF THE INVENTION

In aircraft, for example, a fuselage structure is provided which consists of a plurality of sections. For maintenance or inspection of parts located in the interior of the fuselage, such as for example tanks, it may be necessary to remove individual sections of the fuselage structure in order to provide an opening. The removed sections are then reinserted and connected to one another in order to close the opening. However, it has been shown that the removal and reinsertion of larger structural parts such as fuselage sections can impair the integrity of the structure.

### SUMMARY OF THE INVENTION

An object of the present invention is therefore to provide an improved connecting arrangement for connecting structural parts of an aircraft. This object may be achieved by the subject matter of one or more embodiments described herein. The aspects described below also apply to the aircraft and to the method for connecting structural parts of an aircraft.

According to the invention, a connecting arrangement for connecting structural parts of an aircraft is provided. The connecting arrangement comprises a first structural part with a first flange segment, a second structural part with a second flange segment and a connecting device for connecting the first flange segment and the second flange segment. The first structural part and the second structural part form an outer surface of the aircraft. The first flange segment and the second flange segment abut each other along a connecting plane in a connected state, and each have at least one through-opening, wherein the through-openings are aligned with each other. In the connected state a connecting element of the connecting device protrudes through the through-openings in a connecting direction in order to connect the first flange segment and the second flange segment to each other, wherein the connecting direction runs transversely to the connecting plane and wherein the connecting plane is arranged inclined to the outer surface such that the connecting direction runs obliquely to the outer surface and intersects the latter.

The term “connecting arrangement” refers to an arrangement which represents a structural connecting principle with which structural parts of an aircraft can be connected to each other via a flange principle. The connecting arrangement allows a releasable assembly of larger aircraft structural parts and can also be referred to as a connecting device or as an assembly principle.

In one aspect the connecting arrangement serves to reversibly connect, i.e. releasably connect, structural parts of an aircraft. The connecting arrangement can serve for the assembly and disassembly of structural parts of an aircraft, for example if parts of an airframe are to be temporarily removed and later correctly installed again.

The term “structural part” refers to a section of an aircraft structure, such as for example parts of the fuselage, the wings or the empennages. The structural parts each have flange segments via which they can be connected to one another.

The term “flange segment” refers to a flange which is attached to the structural part. The flange segment comprises at least one through-opening and forms a planar surface which can be placed against a second planar surface of a second structural part flange segment, so that two structural parts can be connected to one another via the flange segments.

The term “through-opening” refers to an opening in the flange segment, such as for example a bore, which is aligned with a through-opening of a second flange segment of a second structural part.

The flange principle allows an assembly or an airframe to be opened and reclosed without damage to the aircraft structure.

The term “connecting plane” refers to the planar surfaces of the flange segments which abut each other in a connected state of the structural parts. The connecting plane can also be referred to as a contact surface.

The term “connecting device” refers to the parts which are required for a fixed connection of the structural parts and comprises for example connecting elements such as screws, bolts, bushings and nuts. A “connecting element” protrudes through the through-openings of the flange segments in the connected state.

The term “connecting direction” refers to an imaginary line between the two through-openings of the structural part flange segments, along which line the connecting element extends for connection and which runs transversely to the connecting plane.

The term “transversely” means “not parallel” but rather for example laterally or at right angles thereto. In other words, “the connecting direction runs transversely to the connecting plane” means that the imaginary line of the connecting direction crosses the connecting plane in any case and can also be perpendicular thereto.

The term “obliquely” means “not parallel” and “not perpendicular”. “The connecting direction runs obliquely to the outer surface” means that the imaginary line of the connecting direction crosses the outer surface in any case.

In one example the connecting direction also runs transversely to the outer surface so that the imaginary line between the two through-openings can also run perpendicularly to the outer surface.

The connecting plane is arranged inclined to the outer surface such that the connecting direction can run not parallel to the outer surface but rather intersects the latter.

The term “inclined” describes a spatial orientation which is not perpendicular and not horizontal but is at an angle to the reference surface and is thus oblique or angled.

The term “outer surface” refers to an outer surface of the aircraft, i.e., a part of the outer surface of the aircraft. The outer surfaces of the structural parts can form the basis for a continuous outer surface of the aircraft, for example an outer surface of the fuselage. If the outer surface still has recesses or openings, the term outer surface refers to an outer surface which is intended to be continuous.

As an option, the outer surface comprises a finishing plate in order to produce a smooth aerodynamic surface, for example a small, non-load-bearing finishing plate.

The advantage of the invention is to provide a self-aligning connection of structural parts which reduces the need for devices and tools during industrial manufacture and in particular the opening and closing of this connection during operation. The oblique positioning of the flanges of the structural parts allows a more compact solution which leads to a significantly lighter construction since no large pockets are required as in the case of a conventional tension bolt connection. The access to the tool is improved in comparison with a perpendicular flange position. The oblique positioning of the flanges and thus of the connecting plane of the structural part flanges also allows the profiles to be aligned globally.

According to one example, the connecting direction runs obliquely to a generatrix formed by the outer surface and intersects the generatrix.

The term “generatrix” refers to a line which runs along the outer surface. For example, the generatrix is a straight line if the outer surface is a planar surface.

According to one example, the connecting direction runs obliquely to a tangent of a curved generatrix formed by the outer surface and intersects the tangent.

The term “tangent” refers to a straight line which touches the curved generatrix of the outer surface at exactly one point without intersecting it.

According to one example, the connecting direction runs perpendicularly to the connecting plane.

The term “perpendicular” in “the connecting direction runs perpendicularly to the connecting plane” refers to the fact that the imaginary line between the two through-openings of the structural part flange segments is at a right angle (i.e. 90 degrees) to the connecting plane.

According to one example, the through-openings form a conical bushing.

The term “conical bushing” refers to a cylindrical connecting element with a conically (i.e. cone-shaped) shaped inner or outer surface.

According to one example, the at least one connecting element is a conical bolt.

The term “conical bolt” refers to a bolt, for example a cylindrical pin or rod, which tapers in the longitudinal direction-i.e. is not cylindrical, but is cone-shaped. A conical bolt can also refer to a conical screw.

The use of conical bolts together with conical bushings allows close play, which can be required for the transmission of the shear load at the interface. Two components can thereby be connected to one another in a centered, fixed and play-free manner.

A local orientation of the structural parts can be achieved by conical bolts and bushings.

According to one example, the connecting arrangement additionally comprises at least one driving pin.

The term “driving pin” refers to a pin which serves to fix the position of the flanges.

The oblique positioning of the contact surface allows the profiles to be aligned globally. By using additional driving pins, the structural part is brought into the correct position and even better global self-alignment on the component plane can be achieved.

The global orientation of the structural parts is thus achieved by the inclined contact surface of the flanges and additional driving pins, while the local orientation can be achieved, for example, by conical bolts.

According to one example, the connecting device further comprises at least one cylinder nut.

The term “cylinder nut” refers to a cylindrical connecting element with internal threads which is used in combination with another connecting element, such as for example a bolt, in order to brace and connect the flange segments of the structural parts to one another.

In one example, a cylinder nut is arranged only on one side of the connecting plane.

The use of cylinder nuts on one side of the connection allows access from only one side, which allows assembly even in complex areas, and improves space utilization.

In one variant, the connecting device comprises a hexagonal or square nut or another suitable type of nut.

According to one example, the structural parts are structural parts of a fuselage section of the aircraft.

The term “fuselage section” refers to a partial region of the fuselage of an aircraft.

According to the invention, an aircraft is also provided. The aircraft has at least one fuselage, a landing gear, wings and empennages. At least two structural parts of the aircraft are connected to the connecting arrangement according to one of the preceding examples.

Structural parts can be for example structural parts of the fuselage, the wings or the empennages.

The term “aircraft” refers to an apparatus which can fly in the air or move through the air. The aircraft can be manned or unmanned, motorized or non-motorized.

The term “fuselage” refers to the central part of the aircraft to which the landing gear, empennage and wings and further components or systems are attached.

According to the invention, a method for connecting structural parts of an aircraft is also provided. The method comprises the following steps: providing a first structural part with a first flange segment; providing a second structural part with a second flange segment; providing a connecting device for connecting the first flange segment and the second flange segment. Wherein the first structural part and the second structural part form an outer surface of the aircraft. The first flange segment and the second flange segment abut each other along a connecting plane in a connected state. The first flange segment and the second flange segment each have at least one through-opening which are aligned with each other. In the connected state a connecting element of the connecting device protrudes through the through-openings in a connecting direction in order to connect the first flange segment and the second flange segment to each other, wherein the connecting direction runs transversely to the connecting plane and wherein the connecting plane is arranged inclined to the outer surface such that the connecting direction runs obliquely to the outer surface and intersects the latter.

According to one aspect, a connecting arrangement for releasably connecting structural parts of an aircraft is provided. The connecting arrangement comprises a first structural part, a second structural part and at least one connecting element. The structural parts each have an obliquely positioned flange segment with a contact surface at which the structural parts can be connected to one another by the at least one connecting element. In the connected state the structural parts form part of an outer surface of the aircraft. A perpendicular to the contact surface of the first or second flange segment in this case intersects the outer surface.

It should be noted that the features of the exemplary embodiments of the connecting arrangement also apply to embodiments of the aircraft and of the method and vice versa.

### BRIEF DESCRIPTION OF THE DRAWINGS

Exemplary embodiments of the invention will be discussed in more detail below with reference to the attached drawings, in which:

FIG. 1 shows an example of a connecting arrangement for connecting structural parts of an aircraft in a schematic cross section.

FIG. 2 shows a further example of a connecting arrangement for connecting structural parts of an aircraft in a schematic cross section.

FIG. 3 shows an example of a connecting arrangement schematically in a lateral plan view.

FIG. 4 shows an example of a connecting arrangement schematically in a lateral plan view.

FIG. 5 shows an example of an aircraft in a cross section.

FIG. 6 shows steps of a method for connecting structural parts of an aircraft in an example.

### DETAILED DESCRIPTION OF THE PREFERRED EMBODIMENTS

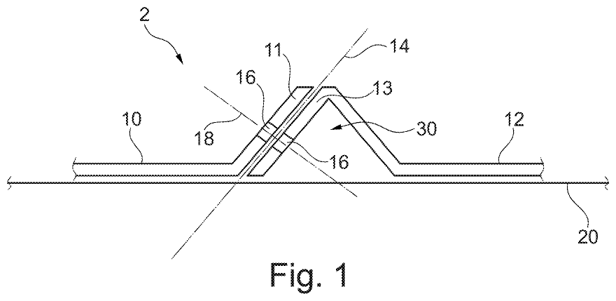

FIG. 1 shows an example of a connecting arrangement 2 for connecting structural parts of an aircraft in a schematic cross section. Shown is a first structural part 10 and a second structural part 12 which together form part of an outer surface of an aircraft. The first structural part 10 has a first flange segment 11 which is arranged obliquely with respect to a generatrix 20 formed by the outer surface. The second structural part 12 has a second flange segment 13 which is also arranged obliquely with respect to the generatrix 20 formed by the outer surface. The two structural parts 10, 12 abut each other with their flange segments 11, 13 along a connecting plane 14 and are thus aligned globally with each other. The flange segments 11, 13 each have through-openings 16 which point towards each other and through which a connecting element of a connecting device can be guided in order to connect the first flange segment 11 to the second flange segment 13. An imaginary line between the two through-openings 16 forms a connecting direction 18 which here runs virtually perpendicularly to the connecting plane 14 and intersects a generatrix 20 formed by the outer surface. In the cross section shown, below the second flange segment 13 of the second structural part 12, a triangular pocket 30 can be seen which results in the configuration of the second structural element 12 shown in this example. A connecting element (not shown here) projecting into the pocket 30 is thus easily accessible from the outside, for example for connecting or disassembling the structural parts.

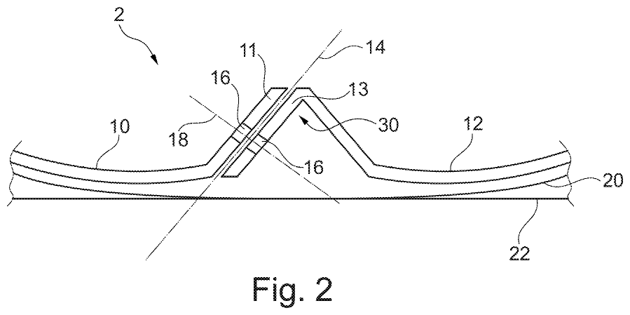

FIG. 2 shows a further example of a connecting arrangement 2 for connecting structural parts of an aircraft in a schematic cross section. The arrangement substantially corresponds to the connecting arrangement 2 shown in FIG. 1 consisting of a first structural part 10, a second structural part 12 and the flange segments 11, 13 thereof each arranged obliquely with respect to a generatrix 20 formed by the outer surface. In the example shown here, the generatrix 20 running along the outer surface is curved because the structural elements 10, 12 are structural elements of a fuselage section of an aircraft and the fuselage of an aircraft generally does not have a planar outer surface. The connecting direction 18 as an imaginary line through the through-openings 16 intersects both the curved generatrix 20 and a tangent 22 of the curved generatrix 20.

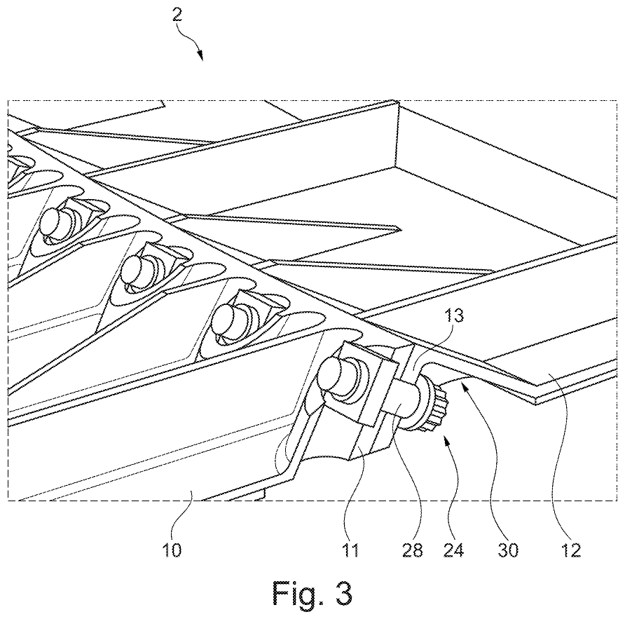

FIG. 3 shows an example of a connecting arrangement 2 schematically in a lateral view from top left. A first structural part 10 with an obliquely arranged first flange segment 11 can be seen. The flange segment 11 is fixedly connected to a second obliquely arranged flange segment 13 of the second structural part 12 via the plurality of connecting devices 24 which are arranged along the flange segments 11, 13. The connecting devices 24 each comprise connecting elements 28 which here have a square nut on the one side and a screw on the other side projecting into the pocket 30. In the flange segment 11 of the first structural part 10, recesses are provided in which the through-openings 16 are located through which the connecting elements 28 of the connecting devices 24 protrude into the triangular pockets 30. In the example shown, the square nuts which form a counterpart to the screws on the connecting elements 28 are arranged in the recesses such that they cannot rotate.

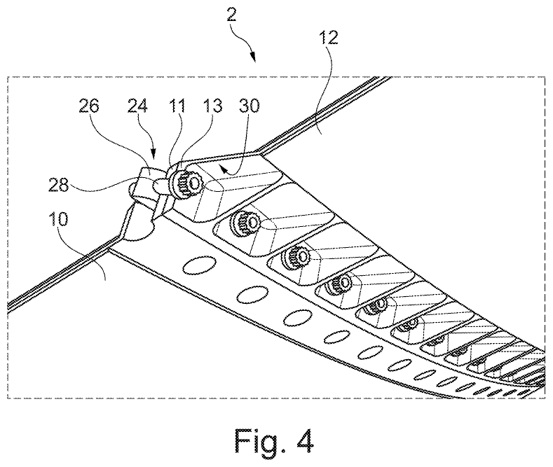

FIG. 4 shows an example of a connecting arrangement 2 schematically in a lateral view from bottom right. The connecting arrangement 2 substantially corresponds to the arrangement shown in FIG. 3 with a first structural part 10 and a second structural part 12. The pockets 30 can be seen into which the connecting elements 28 of the connecting devices 24 protrude. A cylinder nut 26 is located in each case on the side facing away from the pocket 30 as a counterpart to the screws.

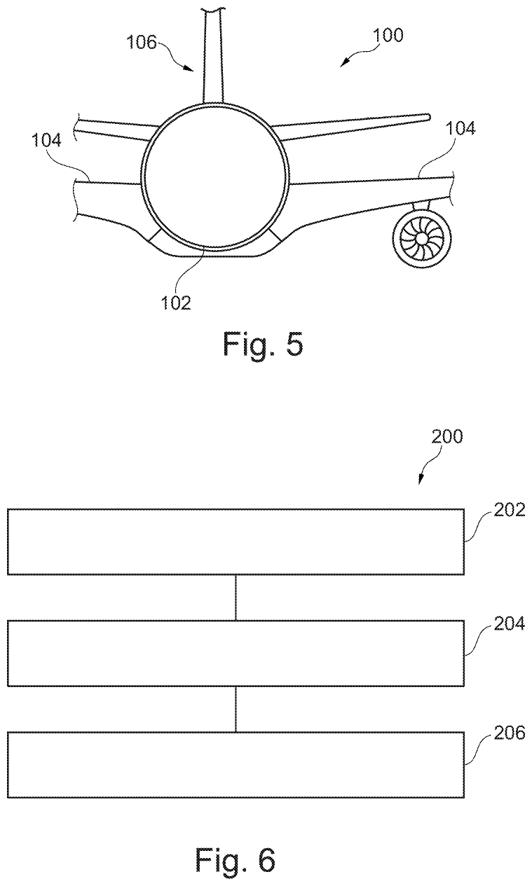

FIG. 5 shows an example of an aircraft 100 in a cross section. The aircraft has a fuselage 102, a landing gear, wings 104 and empennages 106; wherein at least two structural parts of the aircraft 100 are connected to a connecting arrangement 2 described above.

FIG. 6 shows steps of a method 200 for connecting structural parts of an aircraft in an example. In a first step 202, a first structural part with a first flange segment is provided. In a second step 204, a second structural part with a second flange segment is provided. In a third step 206, a connecting device for connecting the first flange segment and the second flange segment is provided. The first structural part and the second structural part form an outer surface of the aircraft, the first flange segment and the second flange segment abut each other along a connecting plane in a connected state, and the first flange segment and the second flange segment each have at least one through-opening which are aligned with each other; wherein in the connected state a connecting element of the connecting device protrudes through the through-openings in a connecting direction in order to connect the first flange segment and the second flange segment to each other; wherein the connecting direction runs transversely to the connecting plane and wherein the connecting plane is arranged inclined to the outer surface such that the connecting direction runs obliquely to the outer surface and intersects the latter.

The exemplary embodiments described above can be combined in different ways. In particular, aspects of the arrangements can also be used for the embodiments of the method and vice versa.

In addition, it should be noted that “comprising” does not exclude any other elements or steps and “a” or “an” does not exclude a plurality. Furthermore, it should be noted that features or steps which have been described with reference to one of the above exemplary embodiments can also be used in combination with other features or steps of other exemplary embodiments described above. Reference signs in the claims are not to be regarded as a restriction.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A connecting arrangement for connecting structural parts of an aircraft, the connecting arrangement comprising:
a first structural part with a first flange segment;
a second structural part with a second flange segment; and
a connecting device for connecting the first flange segment and the second flange segment,
wherein the first structural part and the second structural part form an outer surface of the aircraft,
wherein the first flange segment and the second flange segment abut each other along a connecting plane in a connected state,
wherein the first flange segment and the second flange segment each have at least one through-opening which are aligned with each other,
wherein in the connected state a connecting element of the connecting device protrudes through the at least one through-openings in a connecting direction in order to connect the first flange segment and the second flange segment to each other,
wherein the connecting direction runs transversely to the connecting plane, and
wherein the connecting plane is arranged inclined to the outer surface such that the connecting direction runs obliquely to the outer surface and intersects the outer surface.

2. The connecting arrangement according to claim 1, wherein the connecting direction runs obliquely to a generatrix formed by the outer surface and intersects the generatrix.

3. The connecting arrangement according to claim 1, wherein the connecting direction runs obliquely to a tangent of a curved generatrix formed by the outer surface and intersects the tangent.

4. The connecting arrangement according to claim 1, wherein the connecting direction runs perpendicularly to the connecting plane.

5. The connecting arrangement according to claim 1, wherein the through-openings form a conical bushing.

6. The connecting arrangement according to claim 5, wherein the at least one connecting element is a conical bolt.

7. The connecting arrangement according to claim 1, further comprising:
at least one driving pin.

8. The connecting arrangement according to claim 1, further comprising:
at least one cylinder nut.

9. The connecting arrangement according to claim 1, wherein the structural parts are structural parts of a fuselage section of the aircraft.

10. An aircraft comprising:
a fuselage,
a landing gear,
wings, and
empennages,
wherein at least two structural parts of the aircraft are connected to the connecting arrangement according to claim 1.

11. A method for connecting structural parts of an aircraft, the method comprising the following steps:
providing a first structural part with a first flange segment;
providing a second structural part with a second flange segment; and
providing a connecting device for connecting the first flange segment and the second flange segment;
wherein the first structural part and the second structural part form an outer surface of the aircraft,
wherein the first flange segment and the second flange segment abut each other along a connecting plane in a connected state,
wherein the first flange segment and the second flange segment each have at least one through-opening which are aligned with each other,
wherein in the connected state a connecting element of the connecting device protrudes through the at least one through-openings in a connecting direction in order to connect the first flange segment and the second flange segment to each other,
wherein the connecting direction runs transversely to the connecting plane, and
wherein the connecting plane is arranged inclined to the outer surface such that the connecting direction runs obliquely to the outer surface and intersects the outer surface.
